(19) United States
(12) Patent Application Publication
(10) Pub. No.: US 2025/0390917 A1
(43) Pub. Date: Dec. 25, 2025

(54) METHODS AND SYSTEMS OF FACILITATING PERSONALIZED RECOMMENDATION WITHIN A COMMUNITY MEMBERSHIP-BASED MARKETPLACE

(71) Applicant: Brian Michael Moran, Basking Ridge, NJ (US)

(72) Inventor: Brian Michael Moran, Basking Ridge, NJ (US)

(21) Appl. No.: 19/246,440

(22) Filed: Jun. 23, 2025

Related U.S. Application Data
(60) Provisional application No. 63/662,641, filed on Jun. 21, 2024.

(51) Int. Cl. G06Q 30/0251; G06Q 30/0601; G06Q 40/06

(52) U.S. Cl. CPC G06Q 30/0269; G06Q 30/0631; G06Q 40/06

(57) ABSTRACT

The present disclosure provides a method of facilitating personalized recommendation within a community membership-based marketplace. Further, the method may include receiving a user profile data from a client communication device. Further, the method may include receiving a product metadata from an asset manager device. Further, the product metadata may be associated with a product. Further, the method may include transforming the user profile data into a first vector representation. Further, the method may include transforming the product metadata into a second vector representation. Further, the method may include identifying a recommendation data by calculating a similarity between the first vector representation and the second vector representation. Further, the method may include storing the recommendation data. Further, the method may include transmitting the recommendation data to the client communication device.

The current application claims a priority to the U.S. provisional patent application Ser. No. 63/662,641 filed on Jun. 21, 2024. The current application is filed on Jun. 23, 2025, while Jun. 21, 2025 was on a weekend.

### FIELD OF THE INVENTION

The present invention generally relates to data processing. More specifically, the present invention is methods and systems for facilitating personalized recommendation within a community membership-based marketplace.

### BACKGROUND OF THE INVENTION

The field of data processing is technologically important to several industries, business organizations, and/or individuals.

Asset and wealth management industries have increasing pressures on the operating and economic model of both groups. While some pressures and challenges are unique, they are quickly converging.

This B2B ecosystem represented within asset and wealth management is plagued with an inefficient supply chain from the investment product development at the asset manager to the placement of that investment product at the wealth management firm.

Asset managers often develop new products in a vacuum, focused primarily on the investment integrity of a strategy versus the necessary understanding of what is required from an operational and/or distribution perspective.

Separately, wealth management firms maintain large internal staffs of personnel, with inadequate technology and non-standardized rules of engagement making the experience fraught with friction and expense.

Compounding the fragmented industry operational gaps are inefficient technology stacks creating meaningful economic and productivity burdens on many companies. Existing techniques for facilitating market modeling within a community membership-based network are deficient with regard to several aspects. For instance, current technologies do not eliminate fragmentation in the marketplace, and do not aggregate, democratize and provide efficient workflows between assets and wealth. Further, current technologies are based on a series of individual, people-based protocols that are driven by a manual and subjective process. Further, the current asset and wealth management industries are siloed, and the associated technology stacks are fragmented.

Therefore, there is a need for improved methods and systems for facilitating personalized recommendation within a community membership-based marketplace that may overcome one or more of the above-mentioned problems and/or limitations.

### SUMMARY OF THE INVENTION

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method of facilitating personalized recommendation within a community membership-based marketplace. Further, the method may include receiving, using a communication device, a user profile data from a client communication device. Further, the method may include receiving, using the communication device, a product metadata from an asset manager device. Further, the product metadata may be associated with a product. Further, the method may include transforming, using a processing device, the user profile data into a first vector representation. Further, the method may include transforming, using the processing device, the product metadata into a second vector representation. Further, the method may include identifying, using the processing device, a recommendation data by calculating a similarity between the first vector representation and the second vector representation. Further, the method may include storing, using a storage device, the recommendation data. Further, the method may include transmitting, using the communication device, the recommendation data to the client communication device.

The present disclosure provides a system for facilitating personalized recommendation within a community membership-based marketplace. Further, the system may include a communication device. Further, the communication device may be configured for receiving a user profile data from a client communication device. Further, the communication device may be configured for receiving a product metadata from an asset manager device. Further, the product metadata may be associated with a product. Further, the communication device may be configured for transmitting a recommendation data to the client communication device. Further, the system may include a processing device. Further, the processing device may be configured for transforming the user profile data into a first vector representation. Further, the processing device may be configured for transforming the product metadata into a second vector representation. Further, the processing device may be configured for Identifying the recommendation data by calculating a similarity between the first vector representation and the second vector representation. Further, the system may include a storage device which may be configured for storing the recommendation data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating personalized recommendation within a community membership-based marketplace, in accordance with some embodiments.

FIG. 3B illustrates a continuation of the flowchart of the method 300 of facilitating personalized recommendation within a community membership-based marketplace, in accordance with some embodiments.

FIG. 4 illustrates a flowchart of a method 400 of facilitating personalized recommendation within a community membership-based marketplace including receiving, using the communication device 1102, an engagement preference data from the client communication device, in accordance with some embodiments.

FIG. 5 illustrates a flowchart of a method 500 of facilitating personalized recommendation within a community membership-based marketplace including identifying, using the processing device 1104, an engagement content, in accordance with some embodiments.

FIG. 6 illustrates a flowchart of a method 600 of facilitating personalized recommendation within a community membership-based marketplace including training, using the processing device 1104, the machine learning model, in accordance with some embodiments.

FIG. 7 illustrates a flowchart of a method 700 of facilitating personalized recommendation within a community membership-based marketplace including generating, using the processing device 1104, a modified first vector representation, in accordance with some embodiments.

FIG. 8 illustrates a flowchart of a method 800 of facilitating personalized recommendation within a community membership-based marketplace including associating, using the processing device 1104, the user profile data with the cluster identifier, in accordance with some embodiments.

FIG. 9 illustrates a flowchart of a method 900 of facilitating personalized recommendation within a community membership-based marketplace including generating, using the processing device 1104, a text embedding, in accordance with some embodiments.

FIG. 10 illustrates a flowchart of a method 1000 of facilitating personalized recommendation within a community membership-based marketplace including filtering, using the processing device 1104, the recommendation data, in accordance with some embodiments.

FIG. 11 illustrates a block diagram of a system 1100 of facilitating personalized recommendation within a community membership-based marketplace, in accordance with some embodiments.

FIG. 12 is a flow diagram of a method 1200 for facilitating market modeling within a community membership-based network.

FIG. 13 illustrates a high-level vector database structure and technical stack for middleware microservices 1300 of the application.

FIG. 14 illustrates an architecture and workflow 1400 of back-end databases combining structured and unstructured data associated with the disclosed system.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denote “at least one” but does not exclude a plurality unless the contextual use dictates otherwise. When used herein to join a list of items, “or” denotes “at least one of the items” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g., a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g., username, password, passphrase, PIN, secret question, secret answer, etc.) and/or possession of a machine readable secret data (e.g., encryption key, decryption key, bar codes, etc.) and/or or possession of one or more embodied characteristics unique to the user (e.g., biometric variables such as, but not limited to, fingerprint, palm-print, voice characteristics, behavioral characteristics, facial features, iris pattern, heart rate variability, evoked potentials, brain waves, and so on) and/or possession of a unique device (e.g., a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g., the server computer, a client device, etc.) corresponding to the performance of the one or more steps, environmental variables (e.g., temperature, humidity, pressure, wind speed, lighting, sound, etc.) associated with a device corresponding to the performance of the one or more steps, physical state and/or physiological state and/or psychological state of the user, physical state (e.g., motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g., a real-time clock), a location sensor (e.g., a GPS receiver, a GLONASS receiver, an indoor location sensor, etc.), a biometric sensor (e.g., a fingerprint sensor), an environmental variable sensor (e.g., temperature sensor, humidity sensor, pressure sensor, etc.) and a device state sensor (e.g., a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices.

Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

There is no comparable application that exists today that performs a similar function to the invention that is being described herein.

The current application and invention in process is an iteration of ongoing digital and online development and refinement of traditional manual business methods and processes.

The present disclosure describes methods and systems for facilitating market modeling within a community membership-based network.

Further, the disclosed system may be associated with a community marketplace network application invention. Further, the disclosed system offers membership to enterprises and individuals within the asset and wealth management industries.

The application drives a digitized and simplified approach to the traditional workflows that exist between asset and wealth management firms. The modernization of the home office administration and B2B workflows, while providing access to shared business and technology services via a set of underlying exchanges provides a central destination for information to be collected and shared seamlessly.

The community marketplace network application will be driven by the community membership and associated engagement, and leverage proprietary exchanges, which act as marketplaces of information, business and technology services, and industry data. These exchanges will relate to investments (asset managers), intelligence (industry perspectives and insights), and business solutions (shared professional services), and wealth, and will allow community members to save time and money, while increasing focus on growth.

Participants are brought together through a centralized and standalone democratized marketplace network delivering a more holistic approach to engaging in the required data and information needed for the traditional buying and selling process of packaged investment products (i.e., mutual funds, ETFs, hedge funds, etc.).

Through the application, what was a distributed and disjointed model before, will now be consolidated and includes not only the investment manufacturer (i.e., portfolio managers) and the intermediary buyer (i.e., the financial advisor), but the meaningful and tangential parties impacting the distribution ecosystem.

Further, the disclosed system may be configured for market modeling within a proprietary, community membership-based network application.

To be more specific, this invention focuses on an online, subscription-based platform that utilizes advanced algorithms and data analysis to predict and recommend products or services.

By collecting and organizing data about the marketplace and user preferences, the platform can identify patterns and trends to match users with offerings they are likely to be interested in.

This approach is based on the underlying characteristics of both the users and the products/services, leading to personalized recommendations and increased demand fulfillment.

The purpose of the invention is to guide and optimize engagement between various stakeholders in the community: peer to peer engagement, individual to enterprise engagement, enterprise to enterprise engagement, and each persona group's own unique user journey.

The goal is to eliminate fragmentation in the wealth management community, aggregate, democratize and provide standardized access to data thereby increasing engagement within the community while providing a meaningful impact on unique user journeys and workflows.

The application brings a community experience to the participants.

Through the application's marketplace network, all members can engage one another, while also accessing news and thought leadership content, business services, and/or investment products.

The application will allow members to personalize connectivity and engagement, so that members can leverage educational, informational, investment and/or business services to improve their company's or individual financial future.

Users' engagement with the application is facilitated by allowing for posting of content on a Member's community page.

Through the use of a purpose-built profile, users establish and populate engagement preferences, career interest and experience, as well as unique capabilities and skills only of interest and relevance within the asset and wealth management industry.

Collecting this level of data within the marketplace provides for a personalized experience which can minimize noise, reduce interruption, and increase productivity.

Custom data analytics and reporting within the application allows members to use the underlying data to verify engagement analytics and drive more impactful employee training.

Multi-media resources available through the various exchanges reduce the barriers of access for wealth management firms to reach the underlying investment decision makers (i.e., portfolio managers).

Built in machine learning to the matching algorithms and leveraging AI tools in the database structure allows for continuous improvement of results and enhanced user experience and insights as the application evolves.

The purpose of the application is to drive adoption amongst the asset and wealth manager community.

The objective of the application is to establish a digital distribution workflow through the community application where wealth management firms can navigate to and acquire access to peers, investment intelligence, investment product questionnaires, subject matter expert thought leadership, business solutions providers, and asset managers contacts, all within permitted specifications and guidelines outlined by each respective wealth manager. Separately, asset managers will leverage the community to place investment product, track the community's engagement analytics, and virtually and efficiently connect with approved wealth management clients, reducing the need for costly sales and client service teams.

A key to driving a well informed and aligned community is gathering, storing, and then interpreting the data being collected.

The application collects qualitative and quantitative data regarding engagement preferences, career backgrounds, company and product details, along with ongoing user navigation activity.

Information can be voluntarily shared or automatically scraped utilizing the application's underlying technology stack.

Significant administrative and technical safeguards have been coded and implemented to ensure appropriate permissions are in place to ensure privacy where and when required due to the free exchange of information on the application.

This community experience will be governed by the parameters set by each respective wealth manager on its own landing page that all employees of that wealth manager will access upon logging into the application.

The application will be designed in such a fashion as to custom-curate the landing page for each specific wealth manager with the latest insights, news and solutions relevant for their business.

Members may also post content directly to their own community pages within the application.

Individual employees of the wealth manager will be able to utilize their navigation menu which provides the ability to explore all of the respective capabilities of the digital community through the application.

As part of the onboarding process and ongoing membership requirements for the application, wealth management firms are requested to share their desired engagement preferences as well as their historical and current business needs.

These details, once captured, allow the application, through its machine learning and artificial intelligence, to ensure its broader membership conceptualizes how each member desires to engage, and what information and solutions are relevant to them.

The navigation menu will also bring wealth management members to key points of interest that are unique to the application, including exchanges related to investments, intelligence and news, solutions and vendors, and community page for wealth managers.

The investment exchange is analogous to a marketplace for asset managers that will allow members to search by category for certain attributes, which may include but are not limited to things like asset class, manager name, product vehicle type.

The intelligence exchange allows members to hear directly from leading portfolio managers and strategists in a timely and democratized fashion, instead of the current model where they may receive general product level updates from hundreds of salespeople.

The investment and intelligence exchanges allow for the upload and download of multiple types of multi-media resources to reduce the barriers to access for wealth management firms thereby making it easier for them to access the underlying investment decision makers (i.e., portfolio managers).

The application will provide a mechanism for members to “like” content, provides a bookmarking feature, and allows sharing of content to other members.

Engagement analytics are tracked through the application and this data is made available to members through custom reporting dashboards to track engagement and as an employee training mechanism.

The exchange related to business solutions and vendors allows wealth managers to provide input to the application regarding the categories of capabilities and business services, or the underlying providers they wish to have available to their employees.

The wealth manager community page allows wealth management firms to screen asset managers on certain eligibility criteria, including minimum AUM at firm and product level, performance track record; manager or product searches underway, and then permits sharing of information with approved asset managers; (e.g., general platform updates and announcements; soliciting interest on advisor events).

Sharing their engagement preferences can help remove interruption and overhead from the traditional engagement model. By expressing their preferred methods of interaction, wealth managers can streamline communication and eliminate unnecessary disruptions within the traditional engagement model. Additionally, they gain access to a valuable network of members, allowing them to easily find asset manager representatives, gather information, schedule meetings, participate in live Q&A sessions with portfolio managers, and connect with peers in specialized groups based on shared interests, business models, and preferences.

All asset manager information is being stored in the following locations: proprietary database within the application, the manager's community page (i.e., a landing page for the asset manager), and another module within the application that provides a central diligence hub.

All locations can only be accessed via a limited group of administrators and related personnel.

This centralization of marketing, RFPs and questionnaires and pertinent firm information removes the need for wealth managers to track down all required details manually and digitizes the workflows, while also delivering asset managers a single, efficient hub to deliver their content. This will remove hundreds of hours of personnel time spent on administrative functions.

In order to achieve this enhanced and more personalized engagement, it requires the application to ensure privacy (robust information security policies where access is granted only to permissioned groups and application administrators) and controlled access (by designated group and/or application administrators).

The application collects a significant amount of data that is both qualitative and quantitative, as well as personal and corporate.

Through the application's centralized database, logic is applied to better understand and align how all of the members can engage.

Asset manager data points that are collected include firm profiles, product profiles, product availability, thought leadership and news, transaction history, community navigation and content engagement traffic.

Wealth manager data points that are collected include firm profiles, rules of engagement and eligibility, investment needs, thought leadership and news, solution needs, community navigation and content engagement traffic.

Individual member data points that are collected include engagement preferences, professional backgrounds, investment needs, business solution needs and investment history and experience.

Business solution provider data points that are collected include firm profiles, product or service profiles, thought leadership and news, transaction history, community navigation and content engagement traffic.

All of this information is being captured in a proprietary, custom developed and owned database. The technology stack is interoperable and leverages APIs to offer seamless and secure transfer of information to ensure compliant integration and a positive user experience.

The diagram referenced in Exhibit 1 highlights the commercial dimensions/messaging while Exhibit 2 is a draft structure of the underlying data dimensions ingested to the platform.

Through the use of machine learning and proprietarily developed algorithms, the application will utilize the data collected to increase productivity and engagement satisfaction for its members.

Data points, as detailed above, are not consolidated and collected anywhere else in the industry in one central location as they are within this application.

By warehousing this data in one central location and applying the matching algorithm of the community-based application, the application streamlines the engagement of the members of the community.

The interpretation of the data, as well as the automation of engagement rules, assist the application in driving faster, appropriately aligned and more effective connectivity between community members.

The application collects a broad spectrum of business, personnel, and investment product data.

Within the application there are a series of matching algorithms that will provide faster and more optimally aligned outcomes for community members, for both enterprises and individuals.

The first step in the data workflow is data collection and integration. During this process the application collects and ingests various data sources from the core application suite and data warehouse into a centralized repository; ensures data quality and consistency through preprocessing techniques like cleaning, normalization, and aggregation; utilizes tools like Flink, Kafka Airflow for efficient real-time data processing and analytics; and implements data governance practices to ensure compliance with privacy regulations and protect sensitive member information.

Concurrent with the data collection and integration is the ETL Processes (extract, transform, load). During this step, the application extracts data from the core application suite and data warehouse, aggregates and preprocesses data for further analysis and modeling, and loads the transformed data into a centralized repository for seamless access.

Following the data collection and integration, and the ETL process, the application will perform a certain level of member profiling and segmentation. The application will conduct exploratory data analysis (EDA) to gain insights into member characteristics and behaviors, using machine learning algorithms such as k-means clustering or hierarchical clustering to group members with similar attributes or behaviors; and incorporate profile and experience data, browsing and content engagement history, investment product transaction history patterns, and community interactions for comprehensive member segmentation.

Following the exploratory data analysis (EDA) phase, the application utilizes a vector database to house pre-calculated embeddings, essentially numerical representations, of users, items, and their interactions. This vector database then fuels a custom-built recommendation API, which generates personalized suggestions by retrieving relevant embeddings through queries and employing similarity measures. The vector database is designed to be scalable and efficient, capable of managing substantial amounts of data and delivering real-time recommendations to users.

The application will make specific product and service recommendations. An additional layer of the application is a series of pre-built recommendation models using collaborative filtering algorithms like matrix factorization, alternating least squares (ALS), or neural collaborative filtering. These models will continuously improve through various machine learning features to enhance recommendation accuracy by incorporating contextual information such as time (i.e., month/quarter), location/region, or current trends. The application will employ hybrid recommendation approaches that combine collaborative filtering with content-based filtering or knowledge-based techniques; and serve recommendations via the specially coded recommender API by querying the vector database and applying similarity measures to generate personalized recommendations.

Additionally, the application is structured to utilize natural language processing (NLP) techniques like tokenization, word embeddings, and topic modeling to analyze textual content within the platform and develop a content recommendation system using algorithms such as latent Dirichlet allocation (LDA), word2vec, or BERT embeddings. The application implements user-item embedding models to capture semantic similarities between users and content items, enabling personalized content suggestions; and leverage sentiment analysis to assess member sentiment towards specific topics or content pieces and tailor recommendations accordingly.

The application is designed to optimize engagement for members. The application predicts member engagement using machine learning models such as logistic regression, random forests, or gradient boosting machines (GBMs). The application will incorporate data features such as member profile and career or experience attributes, past engagement behavior, and content preferences into engagement prediction models and then employ reinforcement learning techniques to dynamically optimize engagement strategies based on real-time feedback loops to maximize long-term user engagement. Validation will be done by conducting A/B testing and multivariate testing to experiment with different engagement tactics and measure their impact on member behavior and platform performance.

An additional feature built into the application is performance monitoring and iterative improvement. Key performance indicators (KPIs) are defined and aligned with business objectives, such as member retention (enterprise and individual), membership rates in terms of when they upgrade and/or purchase additional products or services, and member satisfaction scores captured via regular survey engagement. The application will implement monitoring dashboards and analytics tools to track KPIs in real-time and identify performance trends and anomalies; conduct regular performance reviews and post-implementation analyses to assess the effectiveness of machine learning-driven features and initiatives; and use insights gained from data analysis, user feedback, and performance metrics to iterate on machine learning models, algorithms, and platform features iteratively, aiming for continuous improvement and optimization.

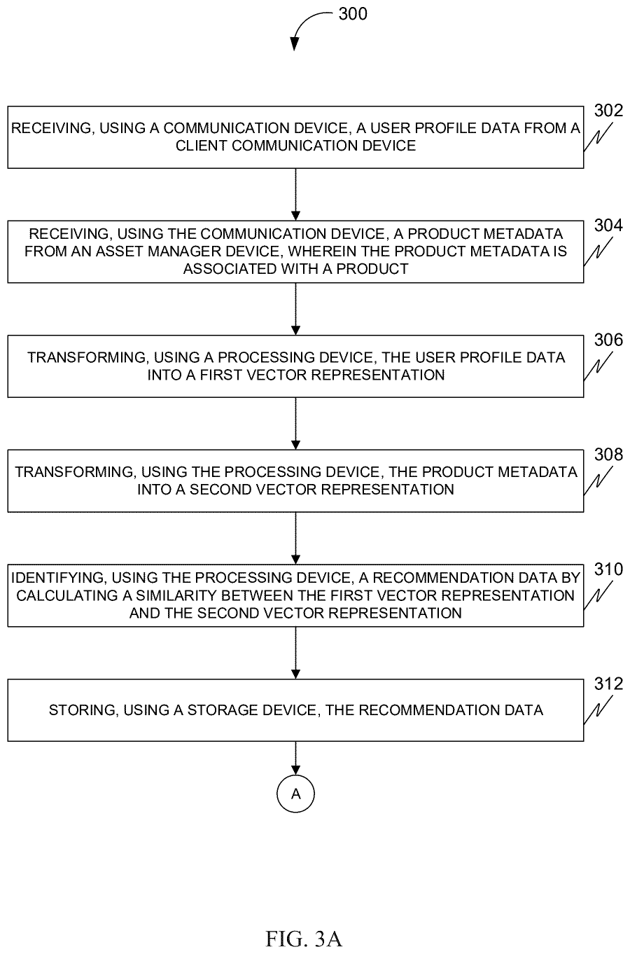

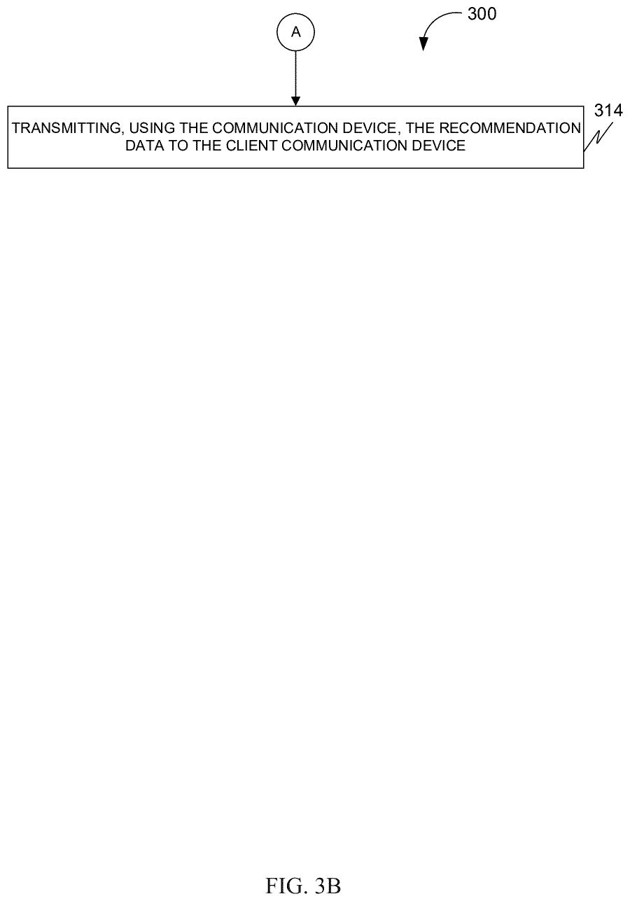

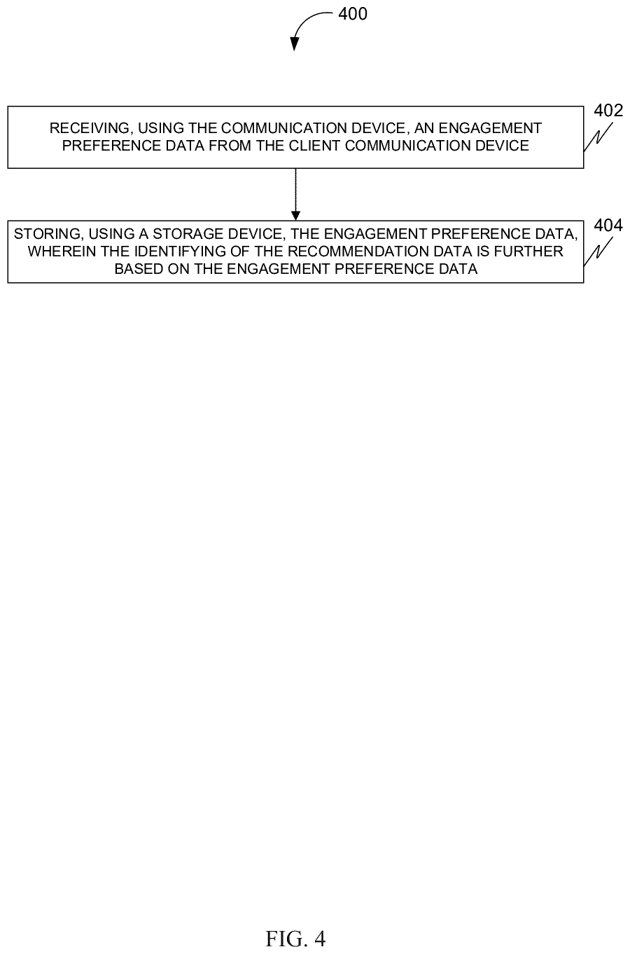

FIG. 3 and FIG. 4 depict the overall architecture and infrastructure components to house the application and the noted features and functionality.

The custom app suite and data warehouse act as repositories for all data sources relevant to the community platform, including member data, content data, product/service data, and engagement data. These components are detailed at a high level in FIG. 4.

The Data Pre-processing and Integration involves cleaning, transforming, and integrating raw data from various sources to prepare it for analysis and modeling.

During the ETL process, the application extracts, transforms, and loads data from various sources, including the core application suite and data warehouse, into the centralized repository for further processing and analysis.

Data is pulled through ETL process from a suite of custom apps into a vector database. As part of this process, the input data is transformed into a vector.

The vector database stores precomputed embeddings or vectors representing users, items, and their relationships, facilitating efficient retrieval and computation of recommendations in real-time which are depicted in FIG. 3.

The recommender API provides a seamless interface for accessing personalized recommendations generated by the recommendations engine, leveraging the vector database to serve these up based on member preferences and ongoing activity/behavior.

An exposed API is used to receive recommendation requests, which are transformed into vector database queries.

This data has now been enriched with other attributes and now becomes a separate data source that can be ingested to the application's matching algorithms and recommendation engine.

Overlaying the entire structure is a level of continuous improvement, which involves monitoring platform performance, collecting user feedback, and iteratively refining machine learning models and algorithms to enhance the platform's learning effectiveness over time.

The application's use of vectors has the ultimate objective to turn a distinct recommendation “option” into a numerical vector. The “recommendation” then becomes a similarity or cluster function, for example k-closest neighbors.

To utilize text, the application must convert the text into word or document embeddings.

For other data types, the application may be creating enumerations of discrete options utilizing custom defined weights and characteristics. For example, examining the fund focus may return a result of 1 for macro, 2 for microcap and 3 for mixed.

The application has certain custom developed matching algorithms that help drive the recommendation framework.

These are deployed in areas where, for example, there is a matching for automated investment search, a matching of service with need, or a matching of events with sponsors or speakers.

Data can then be stored in a standalone database, or in the data warehouse where it can be back tested and continuously improved based on user interaction and engagement.

There are some basic, common components of the matching engine and recommendation framework that have been discussed previously but will be expanded upon further. These include, for example, certain user-based definitions for criteria, weighting, scoring, ranking and final calculations.

For the functionality related to matching an automated investment search, users can define the purpose of the search by utilizing any of the following criteria: Asset class; Vehicle type (multiple or single); Capacity required; Firm minimum requirements (AUM, Ownership, Location, etc.); Product minimum requirements (management team tenure, AUM, inception, fees, performance, etc.); MPT Stats required for initial review; Which platforms and/or investment programs is the search on behalf of; Any operational or implementation considerations (trade rotation policy, manager directed vs model directed trading, etc.); Materials required in submission (Fact Sheet, Presentation, Manager Video(s) on product and/or key personnel); Key Contact Information (title, email, and phone); and Timelines/Deadlines.

Asset managers submit structured responses to the search requirements utilizing any of the available criteria. Through a set of drop downs, the application collects each necessary response.

Certain criteria and responses will be scored and used to determine if additional operational or investment diligence is required.

The application will then assign weights to each matching criterion based on its importance in the selection process. For example, historical performance and risk characteristics (i.e., risk adjusted return) might be weighted more heavily than fees.

Scores are determined along the following lines: Exact (3)—response indicates an exact match to search requirements; Good (1)—response indicates meaningful levels of search requirements being met; Average (0)—response indicates model levels of search requirements being met; Poor (−3)—no match.

To perform the score calculation, the application will aggregate all calculated scores. A minimum score level required to be included in any search recommendations is established.

The application then ranks the investment strategies based on their scores, with the highest-scoring strategies being ranked higher. A default selection of the top 5%, up to 10 investment strategies, which move on for additional diligence review.

If there is a tie in aggregated scores, the tie breaker is determined by importance-the subcategory (i.e., MPT, Vehicle type, etc.) that is suggested to be of the highest importance will rank higher. This process continues until a subcategory difference can be attained.

If all subcategories were to match in score, the submissions will be ranked by recent 3-year performance.

For the functionality related to matching services with needs, the application gathers data from certain proprietary questionnaires and assessments that generate substantial firm specific data that enhances the application's ability to appropriately match business and/or technology services with the needs of a member.

These proprietary questionnaires, which have multiple choice responses, will include details across topics that include: Firm specific (personnel, leadership, legal, location, etc.); Investment Product; Marketing & Media Strategy; Branding Guidelines & Strategy; Content Marketing; Digital Marketing; Event Marketing; Video Capabilities; Website Design; Lead Generation Efforts; Data & Intelligence program; SEO Strategy; Social Media Strategy; Public Relations Strategy; Value Add Capabilities; Historical Sales Results; Traditional Distribution Budget.

Through the application, the hosting entity conducts a comprehensive review of each non-proprietary solutions provider prior to joining the community platform. In this process, the host reviews and analyzes key data related to elements including: People/Culture; Branding; Experience; Digital presence; Competitors; Product Pricing; Revenue Potential; Product/Service Positioning; Product/Service Differentiation; Affiliated Benefits.

Member responses are scored using good, average and poor, which are further described by the following:
Good—(2)—self reported response indicates that there is a need for additional help in their strategy; may also indicate that a respondent has provided an answer that illustrates a clear deficiency in their business strategy.
Average—(0)—indicates that there is neither a need nor satisfaction with their current approach and that they should enter into a marketing lead nurturing campaign.
Poor—(−1)—response indicates satisfaction with current strategy or set of products. May also indicate the respondent answered a binary question that does not require any additional follow-up.

Upon completion of the questionnaires, scores are added together to create category level results. Based upon category results, services and reasons for a recommendation are shared with the respondent.

Categories that receive a positive total sum (i.e., scores added are higher than 0) are aligned with the appropriate set of business or technology services.

The application is then integrated with the sales team to produce an automated soft proposal highlighting areas of consideration as well as estimated financial impacts of implementation.

For the functionality related to matching events with sponsors or speakers, members, through their community page, are able to define event parameters and sponsorship criteria.

For the functionality related to matching member events with wealth management engagement, Wealth Management Firms, through their individual and specific Wealth Management Community Page, post announcements about upcoming events that they or their employees (financial advisors) are hosting.

These announcements may accompany a request for vendor sponsorship or outside speakers. Through the application, Members can submit their interest and automatically be matched as a potential sponsor or speaker.

In addition to matching the member events with advisor engagement, members, through the application, can also define sponsorship criteria.

Wealth Management firms will post an overview of an event that includes details, including: Host (firm, branch, or advisor); Host Lead Contact; venue; location; Theme/Topic; Audience (public or financial advisors or both); Speaker requirements (i.e., deliver presentation, network with attendees, moderate panel); If applicable—length of presentation; Sponsorship amount; Materials requested for meeting (presentation should be submitted; brochure should be submitted, etc.).

Through the application, Members acknowledge they would like to support listed event and have the required capabilities or access provided in order to deliver on the request. Upon the Members submission of interest, they must also provide details including: Materials to be used in meeting (if submitted, include necessary compliance codes where applicable); Do they do business with that firm (1) (if so, how much ($0=(−1); $1-$1 million (0); $1 million-$5 million (1); $5 million+(2)); Do they do business with that branch (if so, how much); Do they do business with that advisor (if so, how much); Are they part of a preferred partner program (Yes receives 2 points; No receives 0); Do they leverage additional community groups (Yes receives 1 point; no receives 0); What materials will be used in meeting (If submitted, include necessary compliance codes where applicable and no compliance codes receive (−1)); Speaker Bio—provide community application membership profile link OR LinkedIn URL (1 point for each); and CC #—if approved, this will be used to pay for the event, unless event is greater than $10,000.

The application will then evaluate each potential sponsor based on how well they meet the defined criteria and scores above. It calculates a score for each sponsor using the weighted criteria and ranks the potential sponsors based on their scores, with the 3 highest-scoring sponsors submitted to Wealth Management Firm.

Post selection, the application allows Wealth Manager to upload a list of all attendees, so that appropriate compliance records can be maintained. A survey will be sent to attendees about the quality of the event, along with an automatically generated recap of the event. The application automatically generates a meeting request that is sent to attendees, on behalf of Member sponsor to schedule one-on-one meetings, phone calls, and/or video conferences. This will also be digitally enabled via a mobile experience for event participants/stakeholders.

Further disclosed herein is a platform (FLX) including an engine (i.e., a matching engine) to drive digital engagement and access opportunities. Accordingly, the platform may be configured to glean insights through a rich ecosystem of content and B2B workflows supported by an exchange framework. Further, the platform may revolutionize engagement by empowering FLX community members to access what they want, when they want, and how they want. Further, the platform may leverage AI/ML/NLP technologies to deliver compelling productivity gains. Further, the platform may provide granular insights gleaned based on community trends and activity, content, firm and user level engagement. Further, the platform may include a centralized multi-media resource hub connecting content providers with content consumers. Further, the platform may be configured to digitize previously manual, inefficient workflows and remove underutilized, siloed and expensive software licenses. Further, the platform may track and/or record Vehicles & availability. Further, the platform may facilitate thought leadership, MPT stats/requirements. Further, the platform may include firm profiles/community pages including indication of expertise, key differentiators, overarching investment philosophy and investment strategies/products. Further, the platform may include member profiles (personas) including indication of job history, investment experience, licenses & associations and coverage (firm, geographic). Accordingly, the platform may facilitate client focused investment utilization & implementation and solution & services (provided/desired manager screening preferences).

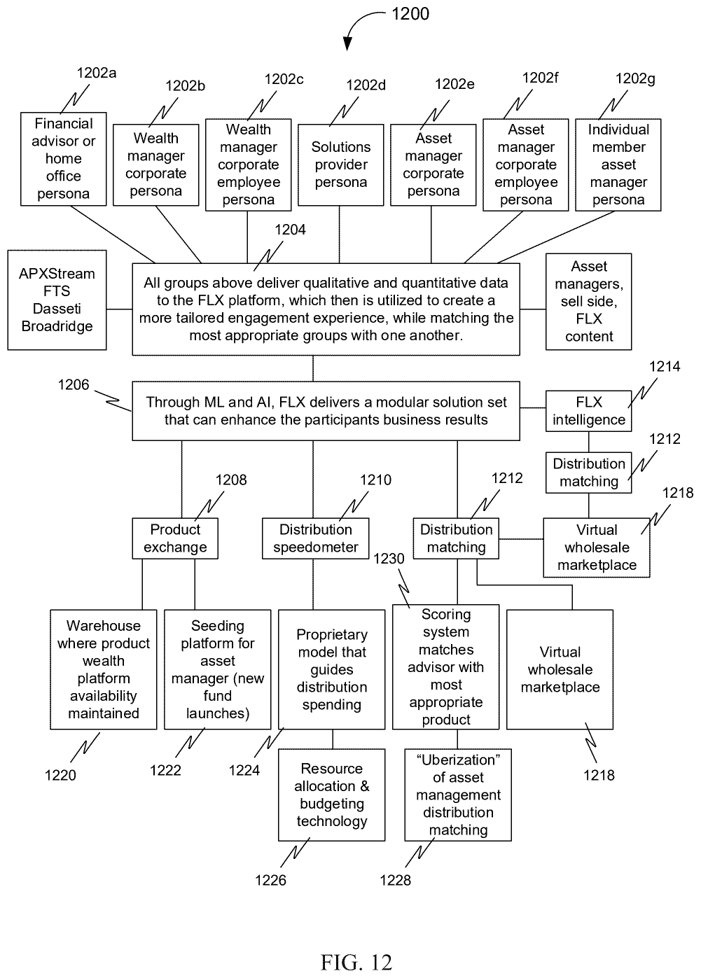

FIG. 12 is a flow diagram of a method 1200 for facilitating market modeling within a community membership-based network. FIG. 12 depicts a more detailed workflow of the inputs and outputs of the community-based application with specific data elements for each to demonstrate the connectivity at the matching levels, for example between the wealth managers and alignment to investment product or between enterprise members and alignment to service providers. Accordingly, the method 1200 may include a step 1202a-g of receiving quantitative and/or qualitative data. Further method may include creating a tailored engagement experience at step 1204. Further, the method may include a step 1206 of delivering a modular solution set based on ML/AI. Further, at step 1208, a product exchange may be provided. Further, at step 1210, a distribution speedometer may be provided. Further, at step 1212 a distribution matching may be provided. Accordingly, at step 1214, FLX intelligence may be provided. Further, at step 1218, a virtual wholesale marketplace may be provided. Further, at step 1220, a warehouse may be provided where product wealth platform availability is maintained. Further, at step 1222, a seeding platform for asset manager (new fund launches) may be provided. Further, at 1224, a proprietary model that guides distribution spending may be provided. Further, at step 1230, a scoring system matches advisor with most appropriate product. Further, at step 1226, resource allocation & budgeting technology may be provided. Further, at 1228, “Uberization” of asset management distribution matching may be provided.

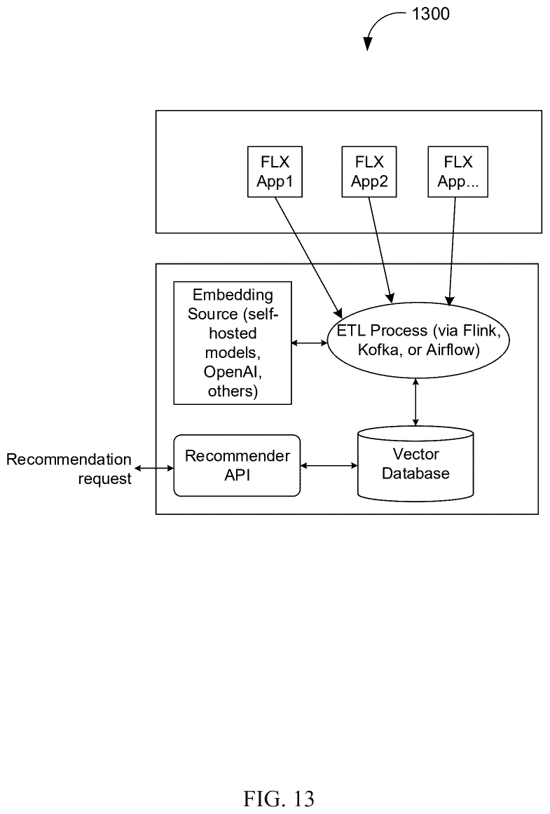

FIG. 13 illustrates a high-level vector database structure and technical stack 1300 for middleware microservices of the application. Accordingly, the application may be built in an efficient and scalable manner, using customary best practices for architecture and development. Further, the vector database structure may be associated with a Matching/Recommender Engine.

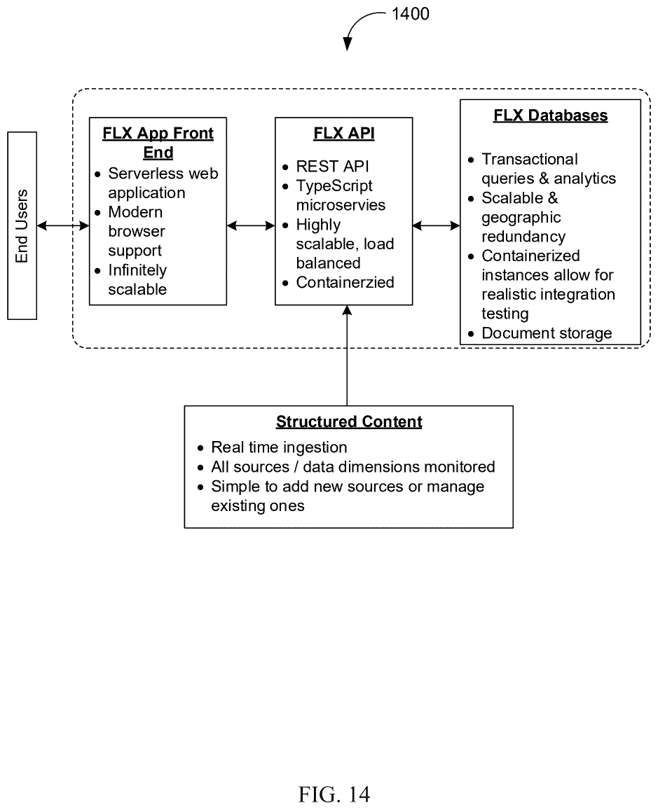

FIG. 14 illustrates an architecture and workflow 1400 of back-end databases combining structured and unstructured data associated with the disclosed system. Accordingly, the front-end may be characterized by a serverless web application with modern browser support and scalable. Further, the API layer may be characterized by features such as REST API, TypeScript microservices, highly scalable, load balanced and containerized. Further, the database layer may be characterized by features such as transactional queries & analytics, scalable & geographic redundancy, containerized instances that allow for realistic integration testing and document storage. Further, the structured content may be characterized by features such as real time ingestion, all sources/data dimensions being monitored, simple to add new sources or manage existing ones.

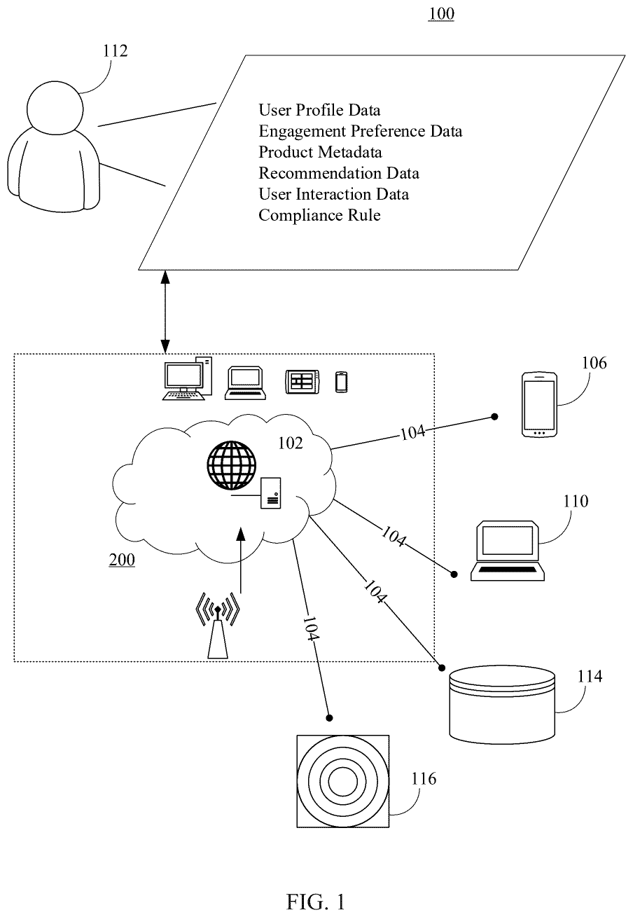

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

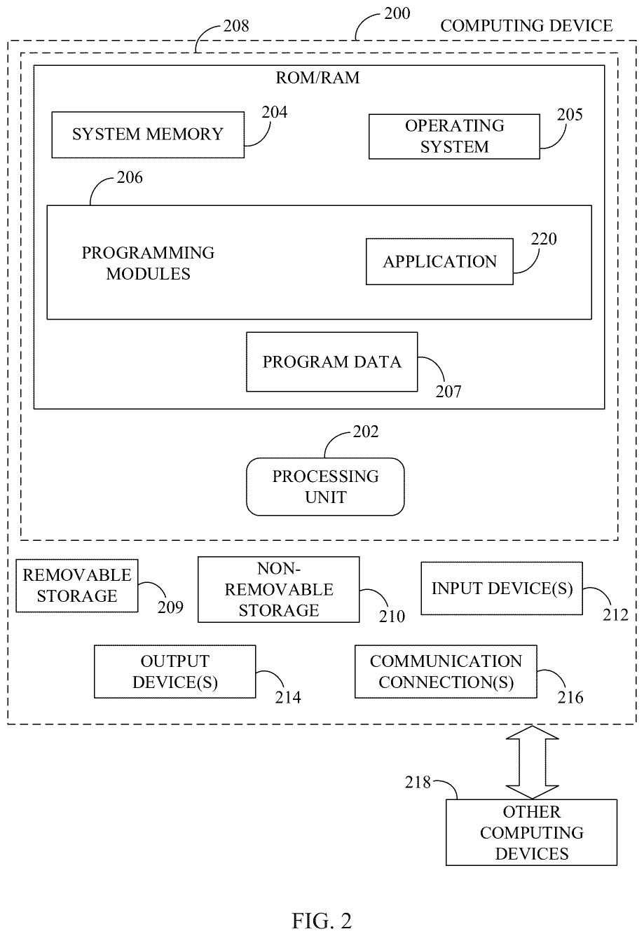

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include an image-processing module and a machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types.

Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

FIG. 3A and FIG. 3B illustrate a flowchart of a method 300 of facilitating personalized recommendation within a community membership-based marketplace, in accordance with some embodiments.

Accordingly, the method 300 may include a step 302 of receiving, using a communication device 1102, a user profile data from a client communication device. Further, the method 300 may include a step 304 of receiving, using the communication device 1102, a product metadata from an asset manager device. Further, the product metadata may be associated with a product. Further, the method 300 may include a step 306 of transforming, using a processing device 1104, the user profile data into a first vector representation. Further, the method 300 may include a step 308 of transforming, using the processing device 1104, the product metadata into a second vector representation. Further, the method 300 may include a step 310 of identifying, using the processing device 1104, a recommendation data by calculating a similarity between the first vector representation and the second vector representation. Further, the method 300 may include a step 312 of storing, using a storage device 1106, the recommendation data. Further, the method 300 may include a step 314 of transmitting, using the communication device 1102, the recommendation data to the client communication device.

FIG. 4 illustrates a flowchart of a method 400 of facilitating personalized recommendation within a community membership-based marketplace including receiving, using the communication device 1102, an engagement preference data from the client communication device, in accordance with some embodiments.

Further, in some embodiments, the method 400, further may include a step 402 of receiving, using the communication device 1102, an engagement preference data from the client communication device. Further, in some embodiments, the method 400, further may include a step 404 of storing, using a storage device 1106, the engagement preference data. Further, the identifying of the recommendation data may be further based on the engagement preference data.

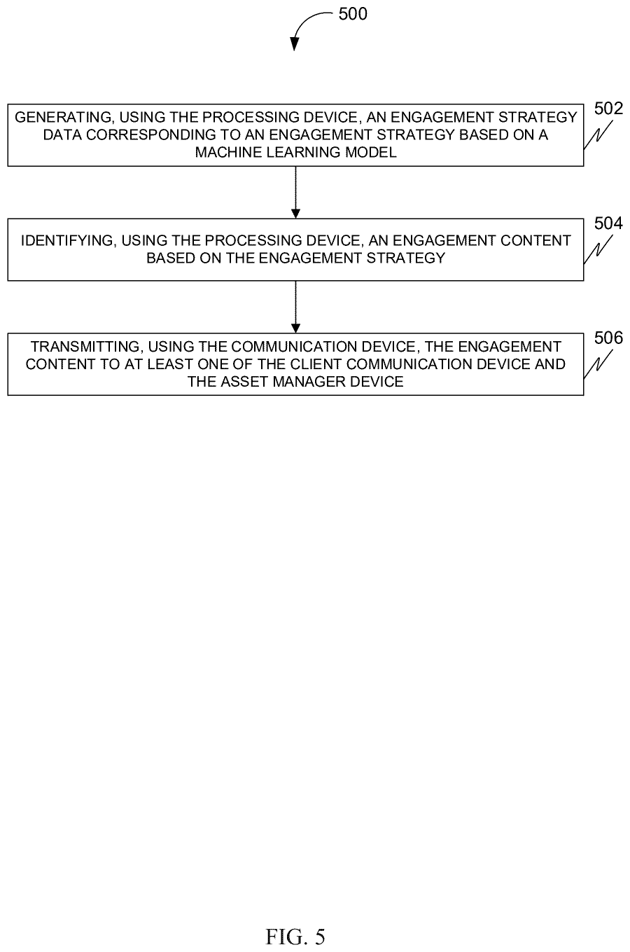

FIG. 5 illustrates a flowchart of a method 500 of facilitating personalized recommendation within a community membership-based marketplace including identifying, using the processing device 1104, an engagement content, in accordance with some embodiments.

Further, in some embodiments, the method 500 further may include a step 502 of generating, using the processing device 1104, an engagement strategy data corresponding to an engagement strategy based on a machine learning model. Further, in some embodiments, the method 500 further may include a step 504 of identifying, using the processing device 1104, an engagement content based on the engagement strategy. Further, in some embodiments, the method 500 further may include a step 506 of transmitting, using the communication device 1102, the engagement content to one or more of the client communication device and the asset manager device.

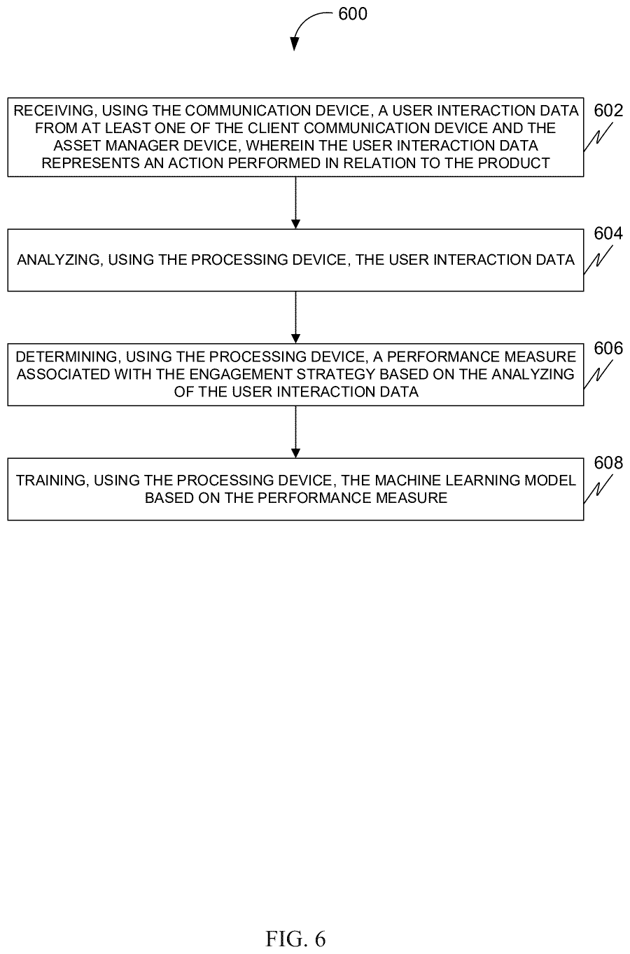

FIG. 6 illustrates a flowchart of a method 600 of facilitating personalized recommendation within a community membership-based marketplace including training, using the processing device 1104, the machine learning model, in accordance with some embodiments.

Further, in some embodiments, the method 600 further may include a step 602 of receiving, using the communication device 1102, a user interaction data from one or more of the client communication device and the asset manager device. Further, the user interaction data represents an action performed in relation to the product. Further, in some embodiments, the method 600 further may include a step 604 of analyzing, using the processing device 1104, the user interaction data. Further, in some embodiments, the method 600 further may include a step 606 of determining, using the processing device 1104, a performance measure associated with the engagement strategy based on the analyzing of the user interaction data. Further, in some embodiments, the method 600 further may include a step 608 of training, using the processing device 1104, the machine learning model based on the performance measure.

In some embodiments, the engagement preference data includes indication of one or more of an asset class, a manager name and a product vehicle type.

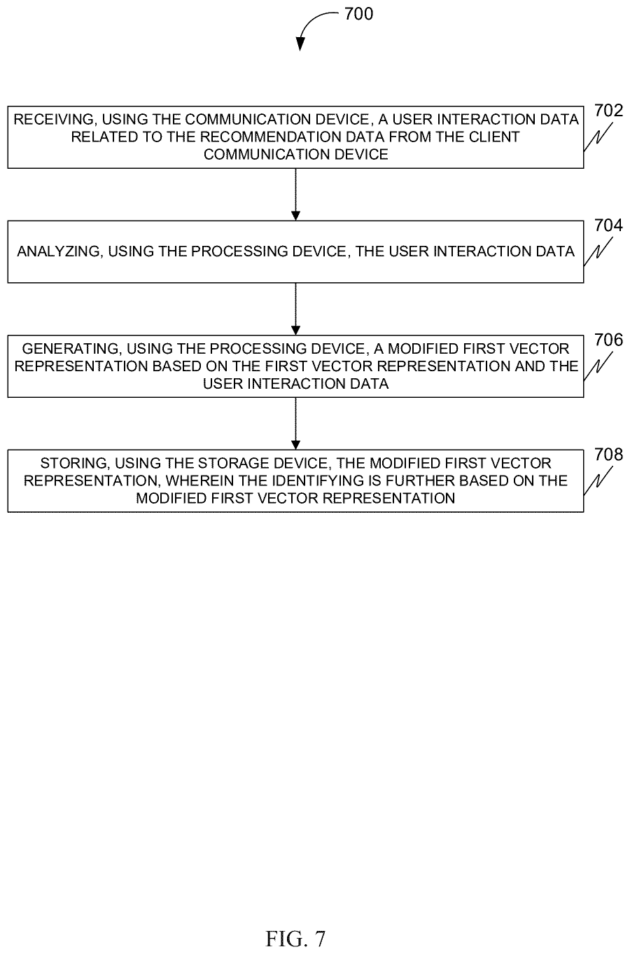

FIG. 7 illustrates a flowchart of a method 700 of facilitating personalized recommendation within a community membership-based marketplace including generating, using the processing device 1104, a modified first vector representation, in accordance with some embodiments.

Further, in some embodiments, the method 700, further may include a step 702 of receiving, using the communication device 1102, a user interaction data related to the recommendation data from the client communication device. Further, in some embodiments, the method 700, further may include a step 704 of analyzing, using the processing device 1104, the user interaction data. Further, in some embodiments, the method 700, further may include a step 706 of generating, using the processing device 1104, a modified first vector representation based on the first vector representation and the user interaction data. Further, in some embodiments, the method 700, further may include a step 708 of storing, using the storage device 1106, the modified first vector representation. Further, the identifying may be further based on the modified first vector representation.

In some embodiments, the user profile data includes a qualitative data and a quantitative data.

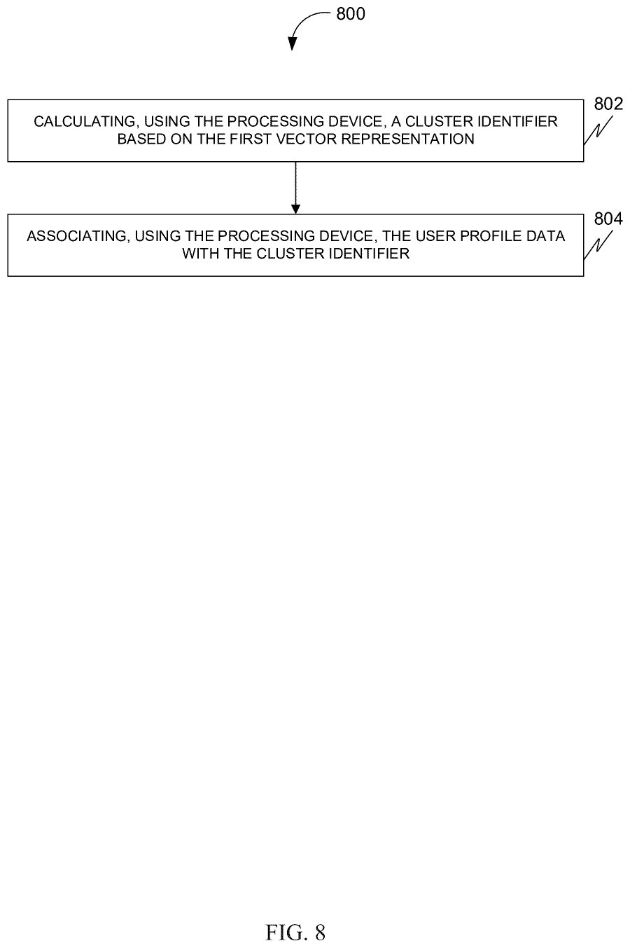

FIG. 8 illustrates a flowchart of a method 800 of facilitating personalized recommendation within a community membership-based marketplace including associating, using the processing device 1104, the user profile data with the cluster identifier, in accordance with some embodiments.

Further, in some embodiments, the method 800, further may include a step 802 of calculating, using the processing device 1104, a cluster identifier based on the first vector representation. Further, in some embodiments, the method 800, further may include a step 804 of associating, using the processing device 1104, the user profile data with the cluster identifier.

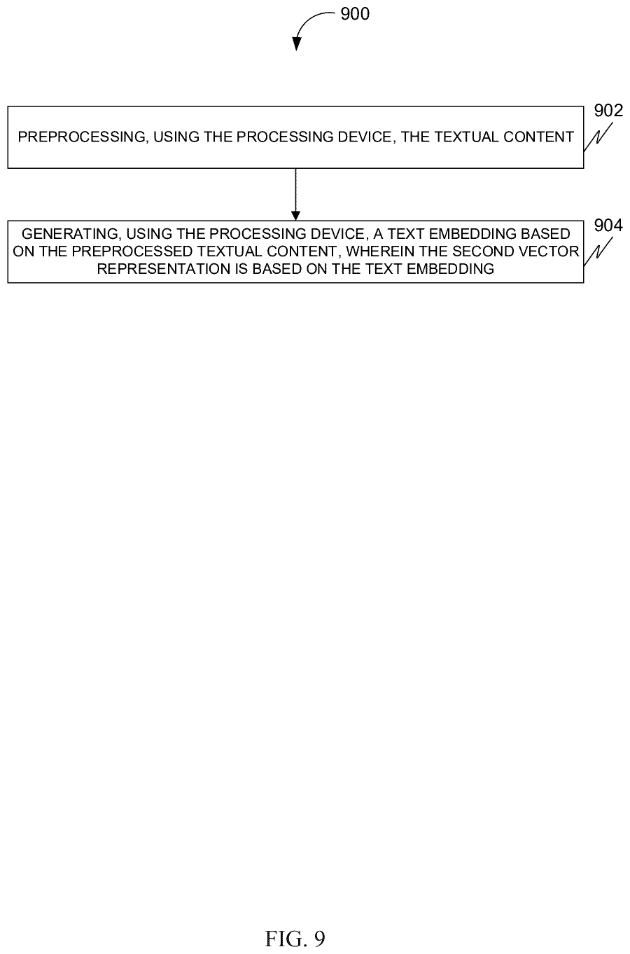

FIG. 9 illustrates a flowchart of a method 900 of facilitating personalized recommendation within a community membership-based marketplace including generating, using the processing device 1104, a text embedding, in accordance with some embodiments.

Further, in some embodiments, the product metadata may include a textual content. Further, the transforming of the product metadata may include a step 902 of preprocessing, using the processing device 1104, the textual content. Further, the transforming of the product metadata may include a step 904 of generating, using the processing device 1104, a text embedding based on the preprocessed textual content. Further, the second vector representation may be based on the text embedding.

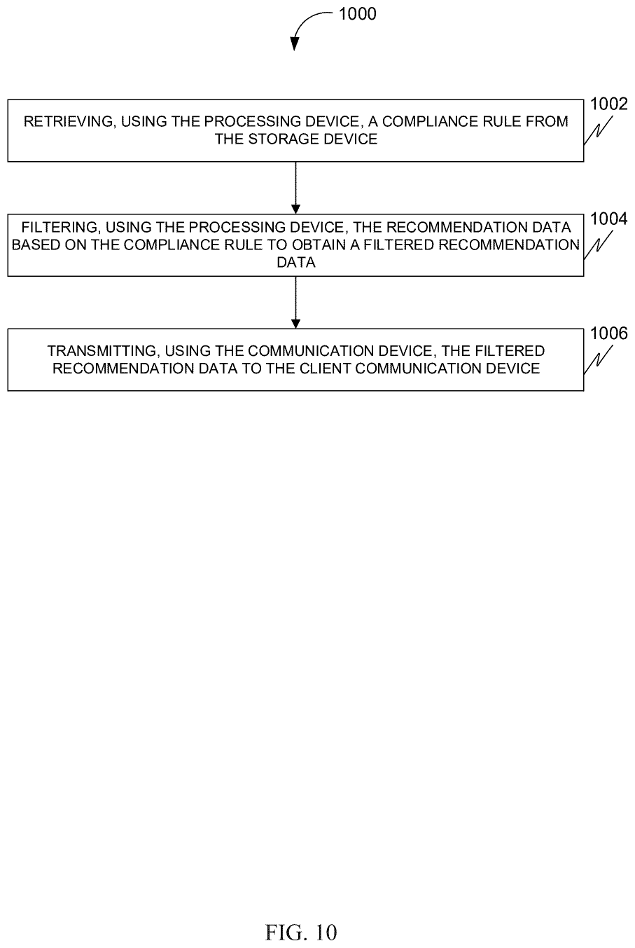

FIG. 10 illustrates a flowchart of a method 1000 of facilitating personalized recommendation within a community membership-based marketplace including filtering, using the processing device 1104, the recommendation data, in accordance with some embodiments.

Further, in some embodiments, the method 1000, further may include a step 1002 of retrieving, using the processing device 1104, a compliance rule from the storage device 1106. Further, in some embodiments, the method 1000, further may include a step 1004 of filtering, using the processing device 1104, the recommendation data based on the compliance rule to obtain a filtered recommendation data. Further, in some embodiments, the method 1000, further may include a step 1006 of transmitting, using the communication device 1102, the filtered recommendation data to the client communication device.

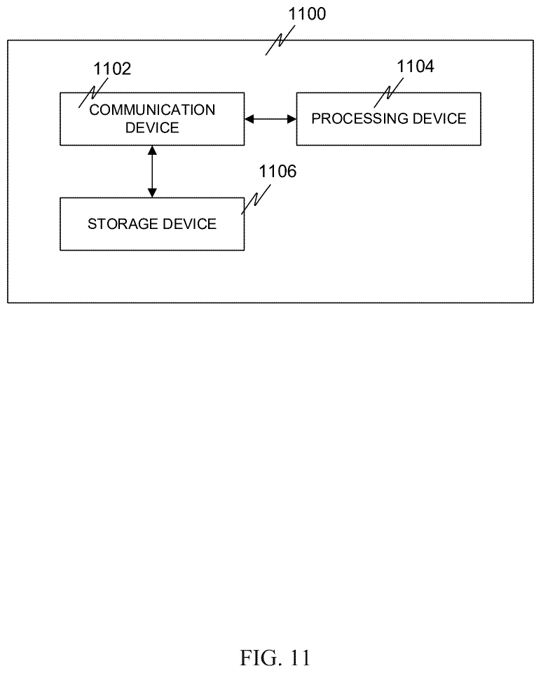

FIG. 11 illustrates a block diagram of a system 1100 of facilitating personalized recommendation within a community membership-based marketplace, in accordance with some embodiments.

Accordingly, the system 1100 may include a communication device 1102. Further, the communication device 1102 may be configured for receiving a user profile data from a client communication device. Further, the communication device 1102 may be configured for receiving a product metadata from an asset manager device. Further, the product metadata may be associated with a product. Further, the communication device 1102 may be configured for transmitting a recommendation data to the client communication device. Further, the system 1100 may include a processing device 1104. Further, the processing device 1104 may be configured for transforming the user profile data into a first vector representation. Further, the processing device 1104 may be configured for transforming the product metadata into a second vector representation. Further, the processing device 1104 may be configured for Identifying the recommendation data by calculating a similarity between the first vector representation and the second vector representation. Further, the system 1100 may include a storage device 1106 which may be configured for storing the recommendation data.

In some embodiments, the processing device 1104 may be further configured for receiving an engagement preference data from the client communication device. Further, the storage device 1106 may be further configured for storing the engagement preference data. Further, the identifying of the recommendation data may be further based on the engagement preference data.

Further, in some embodiments, the processing device 1104 may be further configured for generating an engagement strategy data corresponding to an engagement strategy based on a machine learning model. Further, the processing device 1104 may be further configured for identifying an engagement content based on the engagement strategy, may. Further, the communication device 1102 may be further configured for transmitting the engagement content to one or more of the client communication device and the asset manager device.

Further, in some embodiments, the communication device 1102 may be further configured for receiving a user interaction data from one or more of the client communication device and the asset manager device. Further, the user interaction data represents an action performed in relation to the product. Further, the processing device 1104 may be further configured for analyzing the user interaction data. Further, the communication device 1102 may be further configured for receiving a user interaction data from one or more of the client communication device and the asset manager device. Further, the processing device 1104 may be further configured for determining a performance measure associated with the engagement strategy based on the analyzing of the user interaction data. Further, the communication device 1102 may be further configured for receiving a user interaction data from one or more of the client communication device and the asset manager device. Further, the processing device 1104 may be further configured for training the machine learning model based on the performance measure.

In some embodiments, the engagement preference data includes indication of one or more of an asset class, a manager name and a product vehicle type.

Further, in some embodiments, the communication device 1102 may be further configured for receiving a user interaction data related to the recommendation data from the client communication device. Further, the processing device 1104 may be further configured for analyzing the user interaction data. Further, the processing device 1104 may be further configured for generating a modified first vector representation based on the first vector representation and the user interaction data. Further, the storage device 1106 may be further configured for storing the modified first vector representation. Further, the identifying may be further based on the modified first vector representation.

In some embodiments, the user profile data includes a qualitative data and a quantitative data.

Further, in some embodiments, the processing device 1104 may be further configured for calculating a cluster identifier based on the first vector representation. Further, the processing device 1104 may be further configured for associating the user profile data with the cluster identifier.

Further, in some embodiments, the product metadata may include a textual content. Further, the processing device 1104 may be further configured for preprocessing the textual content. Further, the processing device 1104 may be further configured for generating a text embedding based on the preprocessed textual content. Further, the second vector representation may be based on the text embedding.

In some embodiments, the storage device 1106 may be further configured for retrieving a compliance rule from the storage device 1106. Further, the processing device 1104 may be further configured for filtering the recommendation data based on the compliance rule to obtain a filtered recommendation data. Further, the communication device 1102 may be further configured for transmitting the filtered recommendation data to the client communication device.

Also disclosed herein, is a method for facilitating market modeling within a community membership-based network, in accordance with some embodiments. Accordingly, the method may include obtaining, using a processing device, at least one qualitative and quantitative data. Further, the at least one qualitative and quantitative data may include at least one preference of at least one user.

Further, the method may include storing, using a storage device, the at least one qualitative and quantitative data.

Further, the method may include processing, using the processing device, the at least one qualitative and quantitative data using at least one algorithm. Further, the at least one algorithm may be configured to score and rank the at least one preference.

Further, the method may include generating, using the processing device, at least one score information associated with the at least one preference. Further, the at least one score information may include a score and rank associated with the at least one preference.

Further, the method may include matching, using the processing device, a plurality of users based on a plurality of factors derived from the at least one preference and the at least one score information using at least one second algorithm.

Further, the method may include generating, using the processing device, a matching result based on the matching.

Further, the method may include generating, using the processing device, at least one recommendation based on the generating of the matching result.

Further, the method may include transmitting, using a communication device, at least one of the at least one recommendation and the matching result to at least one user device associated with the at least one user. Further, the at least one user device may include a mobile, a laptop, a smartphone, a tablet, etc. Further, the at least one user may include an individual, an institution, and an organization.

Further, the method may include storing, using the storage device, the matching result and the at least one recommendation.

Further, some aspects of the disclosure in accordance with some embodiments include the following. In terms of a first aspect, a computer implemented method for data processing and matching data entries in a database comprises the steps of: receiving, from a user, a set of qualitative and quantitative data regarding preferences and activity; storing those preferences in a database; accessing a processing unit to apply an algorithm to score and rank said preferences and activity, and storing the resultant data in the database; accessing a processing unit to apply an algorithm to match users within the system based on a plurality of factors derived from preferences and activity and said algorithm for scoring and ranking; and returning results to individual users with specific recommendations based on said matching results.

In terms of a second aspect dependent on the first aspect, the receiving step further comprises the step of: receiving from a user a set of qualitative and quantitative data regarding preferences; receiving from an institution a set of qualitative and quantitative data regarding preferences; receiving from publicly available sources of data, any relevant information to the underlying characteristics of the community-based application; receiving from subscription-based sources of data, any relevant information to the underlying characteristics of the community-based application; and combining said sources of data into a logical and dynamic structure for efficient application processing for end users.

In terms of a third aspect dependent on the first aspect, the matching step further comprises: application by the processing unit of a matching algorithm, wherein each set of criteria are given a certain score for weighting and ranking purposes, and wherein said scores are then tallied to match individual users with potential product or service propensity within the community-based application; and application by the processing unit of a machine learning process to enhance the matching of the set of criteria with the attributes of the data entries.

In terms of a fourth aspect dependent on the first aspect, the enhanced online data processing system receives qualitative and quantitative data from users regarding their preferences and activities. An improved algorithm analyzes this data to score and rank these preferences and activities, while another algorithm matches users within the system based on multiple factors derived from this information. The system then delivers results to users with personalized recommendations tailored to their preferences, activity and matching results, offering a more targeted and relevant user experience.

Although the invention has been explained in relation to its preferred embodiment, it is to be understood that many other possible modifications and variations can be made without departing from the spirit and scope of the invention as hereinafter claimed.

What is claimed is:

1. A method of facilitating personalized recommendation within a community membership-based marketplace, the method comprising the steps of:
receiving, using a communication device, a user profile data from a client communication device;
receiving, using the communication device, a product metadata from an asset manager device, wherein the product metadata is associated with a product;
transforming, using a processing device, the user profile data into a first vector representation;
transforming, using the processing device, the product metadata into a second vector representation;
identifying, using the processing device, a recommendation data by calculating a similarity between the first vector representation and the second vector representation;
storing, using a storage device, the recommendation data; and
transmitting, using the communication device, the recommendation data to the client communication device.

2. The method of claim 1 further comprising the steps of:
receiving, using the communication device, an engagement preference data from the client communication device; and
storing, using a storage device, the engagement preference data, wherein the identifying of the recommendation data is further based on the engagement preference data.

3. The method of claim 1 further comprising the steps of:
generating, using the processing device, an engagement strategy data corresponding to an engagement strategy based on a machine learning model;
identifying, using the processing device, an engagement content based on the engagement strategy; and
transmitting, using the communication device, the engagement content to at least one of the client communication device and the asset manager device.

4. The method of claim 3 further comprising the steps of:
receiving, using the communication device, a user interaction data from at least one of the client communication device and the asset manager device, wherein the user interaction data represents an action performed in relation to the product;
analyzing, using the processing device, the user interaction data;
determining, using the processing device, a performance measure associated with the engagement strategy based on the analyzing of the user interaction data; and
training, using the processing device, the machine learning model based on the performance measure.

5. The method of claim 2, wherein the engagement preference data comprises indication of at least one of an asset class, a manager name and a product vehicle type.

6. The method of claim 1 further comprising the steps of:
receiving, using the communication device, a user interaction data related to the recommendation data from the client communication device;
analyzing, using the processing device, the user interaction data;
generating, using the processing device, a modified first vector representation based on the first vector representation and the user interaction data; and
storing, using the storage device, the modified first vector representation, wherein the identifying is further based on the modified first vector representation.

7. The method of claim 1, wherein the user profile data comprises a qualitative data and a quantitative data.

8. The method of claim 1 further comprising the steps of:
calculating, using the processing device, a cluster identifier based on the first vector representation; and
associating, using the processing device, the user profile data with the cluster identifier.

9. The method of claim 1, wherein the product metadata comprises a textual content, wherein the transforming of the product metadata comprises:
preprocessing, using the processing device, the textual content; and
generating, using the processing device, a text embedding based on the preprocessed textual content, wherein the second vector representation is based on the text embedding.

10. The method of claim 1 further comprising the steps of:
retrieving, using the processing device, a compliance rule from the storage device;
filtering, using the processing device, the recommendation data based on the compliance rule to obtain a filtered recommendation data; and
transmitting, using the communication device, the filtered recommendation data to the client communication device.

11. A system for facilitating personalized recommendation within a community membership-based marketplace, the system comprising:
a communication device configured for:
receiving a user profile data from a client communication device;
receiving a product metadata from an asset manager device, wherein the product metadata is associated with a product; and
transmitting a recommendation data to the client communication device;
a processing device configured for:
transforming the user profile data into a first vector representation;
transforming the product metadata into a second vector representation; and
identifying the recommendation data by calculating a similarity between the first vector representation and the second vector representation; and
a storage device configured for storing the recommendation data.

12. The system of claim 11, wherein the processing device is further configured for receiving an engagement preference data from the client communication device, wherein the storage device is further configured for storing the engagement preference data, wherein the identifying of the recommendation data is further based on the engagement preference data.

13. The system of claim 11, wherein the processing device is further configured for:
generating an engagement strategy data corresponding to an engagement strategy based on a machine learning model; and
identifying an engagement content based on the engagement strategy, wherein the communication device is further configured for transmitting the engagement content to at least one of the client communication device and the asset manager device.

14. The system of claim 13, wherein the communication device is further configured for receiving a user interaction data from at least one of the client communication device and the asset manager device, wherein the user interaction data represents an action performed in relation to the product, wherein the processing device is further configured for:
analyzing the user interaction data;
determining a performance measure associated with the engagement strategy based on the analyzing of the user interaction data; and
training the machine learning model based on the performance measure.

15. The system of claim 12, wherein the engagement preference data comprises indication of at least one of an asset class, a manager name and a product vehicle type.

16. The system of claim 11, wherein the communication device is further configured for receiving a user interaction data related to the recommendation data from the client communication device, wherein the processing device is further configured for:
analyzing the user interaction data; and
generating a modified first vector representation based on the first vector representation and the user interaction data, wherein the storage device is further configured for storing the modified first vector representation, wherein the identifying is further based on the modified first vector representation.

17. The system of claim 11, wherein the user profile data comprises a qualitative data and a quantitative data.

18. The system of claim 11, wherein the processing device is further configured for:
calculating a cluster identifier based on the first vector representation; and
associating the user profile data with the cluster identifier.

19. The system of claim 11, wherein the product metadata comprises a textual content, wherein the processing device is further configured for:
preprocessing the textual content; and
generating a text embedding based on the preprocessed textual content, wherein the second vector representation is based on the text embedding.

20. The system of claim 11, wherein the storage device is further configured for retrieving a compliance rule from the storage device, wherein the processing device is further configured for filtering the recommendation data based on the compliance rule to obtain a filtered recommendation data, wherein the communication device is further configured for transmitting the filtered recommendation data to the client communication device.
